(19) United States
(12) Patent Application Publication
(10) Pub. No.: US 2003/0070178 A1
(43) Pub. Date: Apr. 10, 2003

(54) Poker tournament system

(76) Inventors: Robert A. Boyd, Columbia, MO (US); Russell A. Boyd, Columbia, MO (US); Sami K. Vaaraniemi, Heksinki (FI)

Correspondence Address: Greensfelder, Hemker & Gale, P.C., Suite 2000, 10 South Broadway, St. Louis, MO, 63102, US

(21) Appl. No.: 10/238,151

(22) Filed: Sep. 9, 2002

Related U.S. Application Data
(60) Provisional application No. 60/318,297, filed on Sep. 9, 2001.

(51) Int. Cl. H04N 7/173; H04N 7/16

(52) U.S. Cl. 725/110; 725/109; 725/135

(57) ABSTRACT

An electronic system for providing gaming tournaments in a computer-networked environment is disclosed comprising several servers and a database.

### BACKGROUND OF THE INVENTION

1. Field of the Invention

The present invention relates to method for providing gaming tournaments in a computer-networked environment, and more particularly to methods for providing multi-player poker tournaments over the Internet.

2. Prior Art

Poker is a well-known card game that has existed for hundreds of years. However, there is no one universal game of “poker”. Rather, there are various types of poker, each with its own rules that are based in the same general set of principles. Poker usually involves one deck of 52 playing cards, where the 52 cards are comprised of 13 different ranks (i.e., A, 2, 3, 4, 5, 6, 7, 8, 9, 10, J, Q, and K) and four different suits (i.e., hearts, diamonds, spades, and clubs). During hands of play, a dealer deals players cards from the deck. It is the player's object to put together the best five-card hand possible from the cards that he has available. The player may wager money in one or more betting rounds against the other players that are added to the pot. After the betting rounds are completed and there are no cards left to deal, a showdown occurs in which the players reveal their cards. The player with the best hand wins the show down and wins the pot.

The winner of a showdown is guaranteed winnings from the pot because of an ante. The ante is money (money and chips are used interchangeably herein) that is given by one or more players to initialize the pot before any cards are dealt. The ante maybe provided either by a select number of players or by all of the players. A community ante is when every player puts in some of its own money at the start of each hand. Additionally or alternatively, individuals can be selected to pay antes by a revolving blind, wherein one or more players are required to pay a preset ante into the pot. Thus, the ante each round can be paid through a revolving small blind and big blind.

After the ante is entered into the pot, everyone sitting at the table is dealt cards. The number of cards dealt, whether the cards are dealt face up or face down, and the timing and number of betting rounds depend on the type of game being played. At the end of a particular round, whoever has the best hand wins the particular pot.

Evaluation of which player has the best hand is based on the difficulty in making a particular hand. The traditional order of hands from worst to best with a 52 card deck is as follows: high card, pair, two pair, three of a kind, straight, flush, full house, four of a kind, and straight flush. A high card is when none of the cards are of the same rank, the five cards are not consecutive, and the five cards are not of the same suit. A pair is when two of the five cards match in rank. Two pair is when there are two sets of two cards that match in rank. Three of a kind is when there are have three cards of the same rank. A straight is when there are five cards of consecutive ranks but not of the same suit. A flush is when there are five cards of the same suit but they are not consecutive in rank. A full house is when the player has a three of a kind and a two of a kind. Four of a kind is when the player has four cards of the same rank.

The initial player to act may be determined in several different ways. First, the initial player to act may be chosen because of its position relative to the dealer (e.g., 1 position clockwise from the dealer.) Second, the initial player to act may be chosen because of its position relative to a rotating dealer button, where each player takes his turn in possession of the dealer button. Finally, the initial player to act may be chosen because of the cards he has showing (e.g., whoever has the highest exposed card showing is the first to act).

Poker has at least one betting round. During a betting round, there is one of four actions that players may be able to make. The initial player can either check, bet, or fold. Checking is when the player wishes to continue playing with his hand, but does not wish to bet anything additional. Folding is when the player no longer wishes to continue playing with his hand by giving up any ante he has made to the pot. A player who has folded will no longer receive cards. Betting is placing a certain dollar amount into the pot and thereby allowing the player to continue with his hand and also requiring other players to call, raise, or fold. Calling is when a player wishes to continue with his hand by matching the outstanding bet. Raising is when a player wishes to continue with his hand by exceeding the outstanding bet, so that all other players must at least match the new outstanding bet to continue playing. When there is no bet in existence, a player can check which means that they are not going to put any more money in but they will continue to hold onto their hand. If there is a bet, players cannot check. They must at least call the bet, or else they can fold their hand. In a betting round, this procedure continues until everybody has had a chance to act. As a general rule, raises must be equal to at least as much as the last raise. So if the first person bets five, a person raising the bet must raise by at least five.

Games of poker may be differentiate by whether they are open or closed games of poker. Open poker games involve exposing some cards to other players, such as in games of 5-card stud or 7-card stud. In these games, players receive some of the cards down (i.e., unexposed to other players) which may only be exposed to the individual player to whom the card was given. The player then receives additional open cards that are exposed to everyone. Players make decisions based on what they know about their own hand and what they know about everyone else's hand. Thereby, there actions are based on the complete information about their own hand and the incomplete information about everyone else's hand. Texas Hold'em is a form of open poker. In this game, players receive two cards that are face down, and five community cards that are exposed.

There is also closed poker. In closed poker, the cards received by each player the other players do not see. A form of closed poker is 5-card draw. In the 5-card draw, players receive their five cards face down, there is a betting round, and then a drawing round such that people can replace up to three, and sometimes four of their cards.

The final distinction with the various games of poker is how the pot is divided up at the end of a particular game. In some games, players try to have the highest hand possible. Other games players may try to have the lowest hand possible. Other times, the pot will be split such that half will go to the highest hand, and the other half goes to the lowest hand.

There are many ways that a group of people may play organized poker together. For example, rings games are standard games of poker that are not part of a tournament setting. The ring games are limited to the players participating at a single table. Further, ring games have a fixed limit and game structure. Ring games almost always have a rake, which is where a percentage of each pot is kept out of play and is given to the house for their profit. Tournament games are usually not raked, but instead have a “buy-in” for which a percentage goes to the house to cover expenses, profit, and tournament payout.

When operating a poker tournament the percentage of money from the buy-in fee that does not go towards the winning persons in a tournament depends on the tournament size and entry fee. Traditionally, the buy-in must cover the costs of running the tournament, which in “brick and mortar” casinos may be quite costly as it is expensive to pay the various dealers and personnel necessary to run a tournament the following system provides a means for providing. On the other hand, online tournaments over the Internet require relatively minimal human effort and are therefore relatively much less expensive and time consuming to manage.

At the time of the present invention, other companies offer poker ring games online. However, none of the other companies has been able to operate multiple tournaments for real money.

Therefore, there appears a need in the art for an electronic poker tournament system that provides for the efficient operation of multiple poker tournaments over a networked system.

### OBJECTS AND SUMMARY OF THE INVENTION

Accordingly, the primary object of the present invention is to provide an electronic system for the efficient operation of multiple poker games.

Another object is to provide an electronic gaming system flexible enough to adjust to any style of poker.

A further object of the present invention is to provide a secure system designed to transfer monetary funds.

Another further object of the present invention is to provide a networked environment of two or more computers capable of exchanging gaming information related to multiple poker tournaments either over the Internet or in an intranet system.

Yet a further object of the present invention is to provide a software-related system comprising a number of servers for providing for multiple poker tournaments.

Another object of the present invention is to provide an encryption system between clients, servers and a database that allows for secure communications.

Yet another further object of the present invention is to provide a system of unique identification for each player in the poker tournament.

These and other objects of the present invention are realized in the preferred embodiment of the present invention, described by way of example and not by way of limitation, which provides for a poker tournament system.

In brief summary, the present invention overcomes and substantially alleviates the deficiencies in the prior art by providing a networked environment capable of operating multiple poker tournaments on either an internet or intranet system. The poker tournament system of the present invention comprises a computer-implemented system having a software subsystem that provides a means for operating one or more multiple poker tournaments.

Additional objects, advantages and novel features of the invention will be set forth in the description which follows, and will become apparent to those skilled in the art upon examination of the following more detailed description and drawings in which like elements of the invention are similarly numbered throughout.

### BRIEF DESCRIPTION OF THE DRAWINGS

FIG. 1 is a simplified block diagram showing the poker tournament system according to the present invention;

FIG. 2 is a table showing a sample tournament script according to the present invention;

FIGS. 2A-2D are data structures showing static parameters of tournament and log tournament results according to the present invention;

FIG. 3 is a display screen showing a tournament waiting list according to the present invention;

FIG. 4 is a display screen showing another tournament waiting list according to the present invention;

FIG. 5 is dialog screen showing tournament details according to the present invention;

FIG. 6 is a display screen showing an operator's console according to the present invention;

FIG. 7 is a display screen showing the start of a tournament with the gaming tables being spawned according to the present invention;

FIG. 8 is a display screen showing the start of the tournament with the players being seated at their tables;

FIG. 9 is a display screen showing the start of the tournament with open seats being made open for latecomers according to the present invention;

FIG. 10 is a display screen showing the tournament as started with the first poker hands being dealt according to the present invention;

FIG. 11 is a dialog screen showing the progression of the game according to the present invention;

FIG. 12 is a display screen showing a hand being dealt according to the present invention;

FIG. 13 is a display screen showing the time left to act according to the present invention;

FIG. 14 is a display screen showing the tournament as frozen according to the present invention;

FIG. 15 is a dialog screen showing no new players being allowed to join the tournament according to the present invention;

FIG. 16 is a display screen showing one poker table being dissolved with six table left according to the present invention;

FIG. 17 is a dialog screen showing poker table details according to the present invention;

FIG. 18 is a display screen showing the blinds rise according to the present invention;

FIG. 19 is a display screen showing the poker hand in progress according to the present invention;

FIG. 20 is a display screen showing the tournament paused for a break according to the present invention;

FIG. 21 is a dialog screen showing the current tournament status according to the present invention;

FIG. 22 is a dialog screen showing the final standing of a particular player according to the present invention;

FIG. 23 is a display screen showing a player about to be eliminated from the tournament according to the present invention;

FIG. 24 is a dialog screen showing the results of a particular hand according to the present invention;

FIG. 25 is a display screen showing that the table has been dissolved according to the present invention;

FIG. 26 is a dialog screen showing another tournament status report according to the present invention;

FIG. 27 is a display screen showing the betting limits for a particular game according to the present invention;

FIG. 28 is a display screen showing three players left at a poker table according to the present invention;

FIG. 29 is a display screen showing the previous table being dissolved with players having been seated at a final table according to the present invention;

FIG. 30 is a dialog screen showing a player's final standing according to the present invention;

FIG. 31 is a display screen with a dialog screen inset showing final poker table details according to the present invention;

FIG. 32 is a dialog screen showing the winning player according to the present invention;

FIG. 33 is a dialog screen showing tournament details according to the present invention;

FIG. 34 is a dialog screen showing a congratulations message to the winner according to the present invention;

FIG. 35 is display screen showing an operator's console according to the present invention;

FIG. 36 is a flow chart diagram showing the flow logic of the present invention

FIG. 37 is a flow chart diagram showing the flow logic of the present invention;

FIG. 38 is a flow chart diagram showing the flow logic of the present invention;

FIG. 39 is a flow chart diagram showing the flow logic of the present invention;

FIG. 40 is a flow chart diagram showing the flow logic of the present invention; and

FIG. 41 is a table of callouts references to the detailed description of the specification according to the present invention.

### DETAILED DESCRIPTION OF THE INVENTION

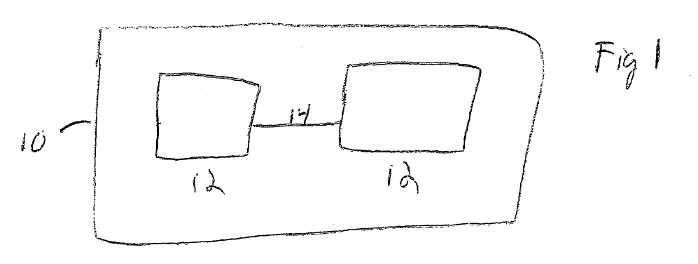

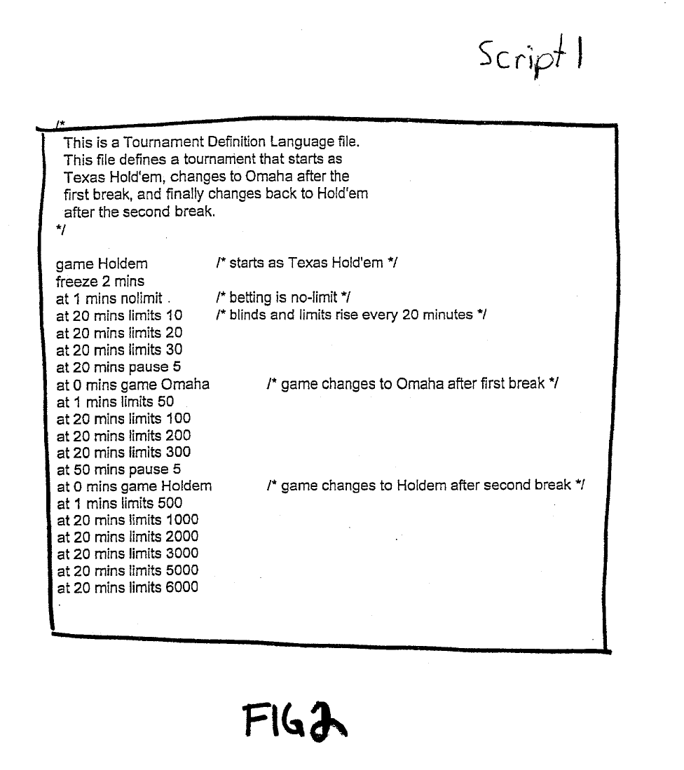

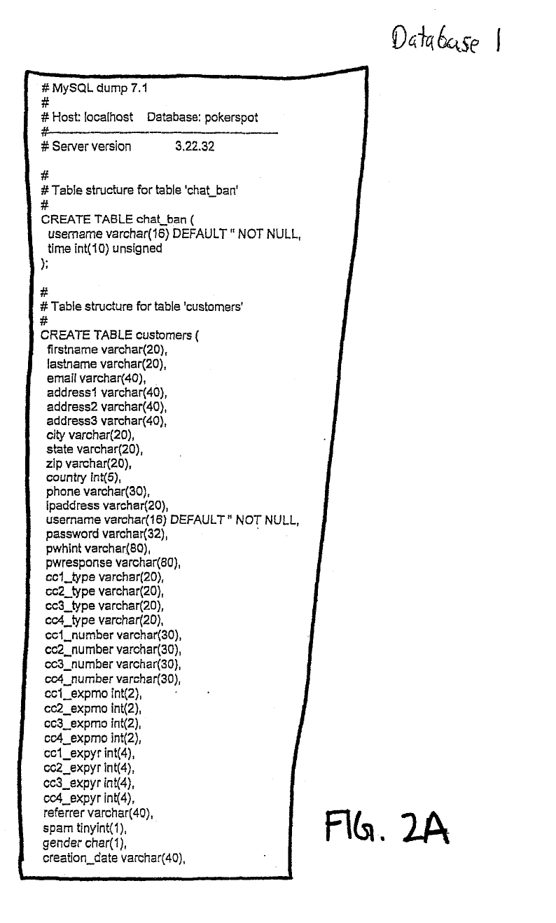

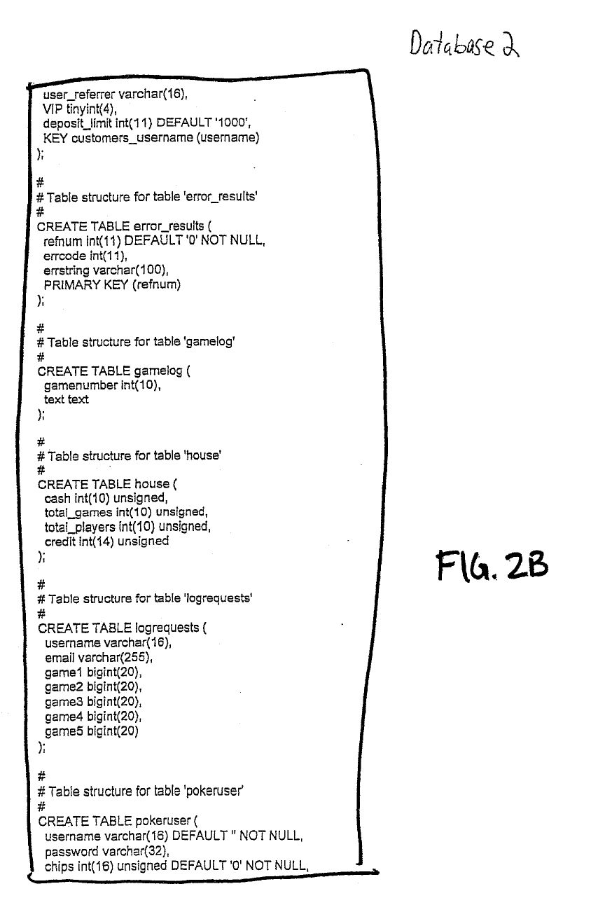

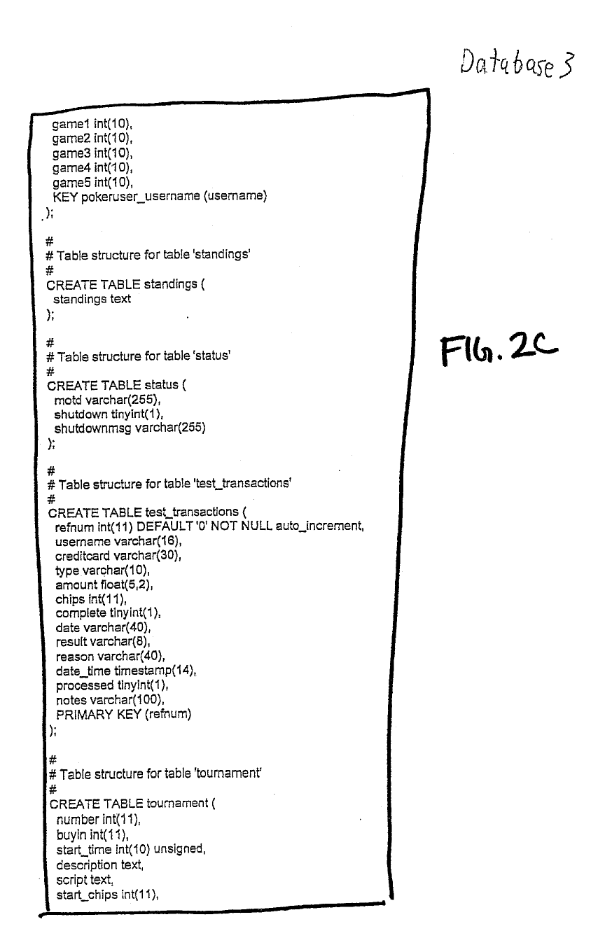

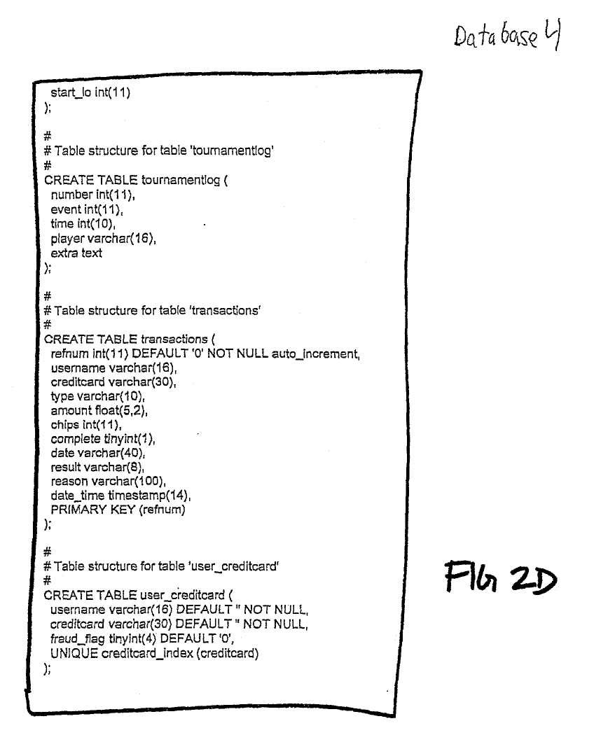

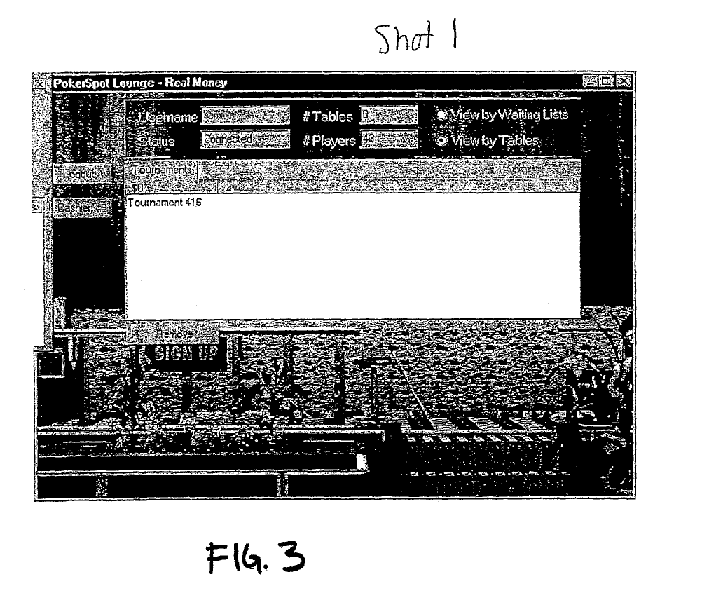

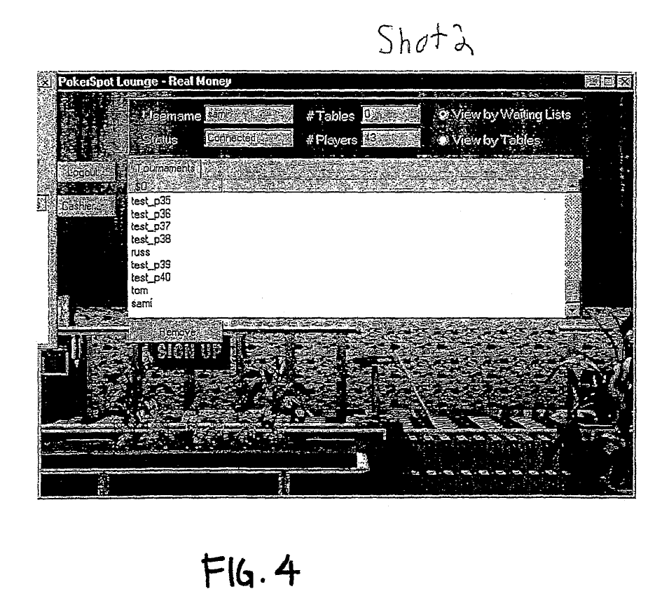

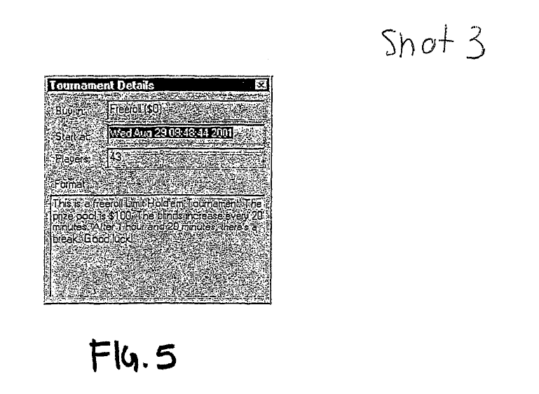

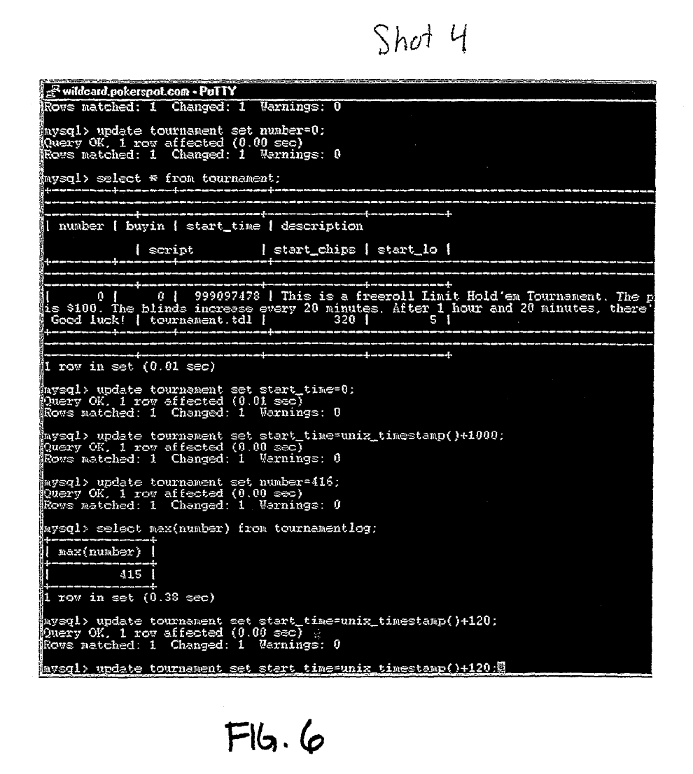

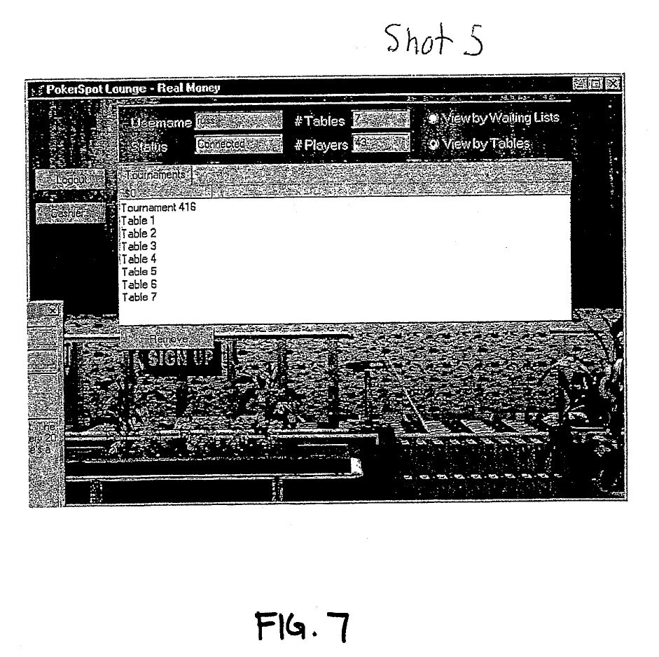

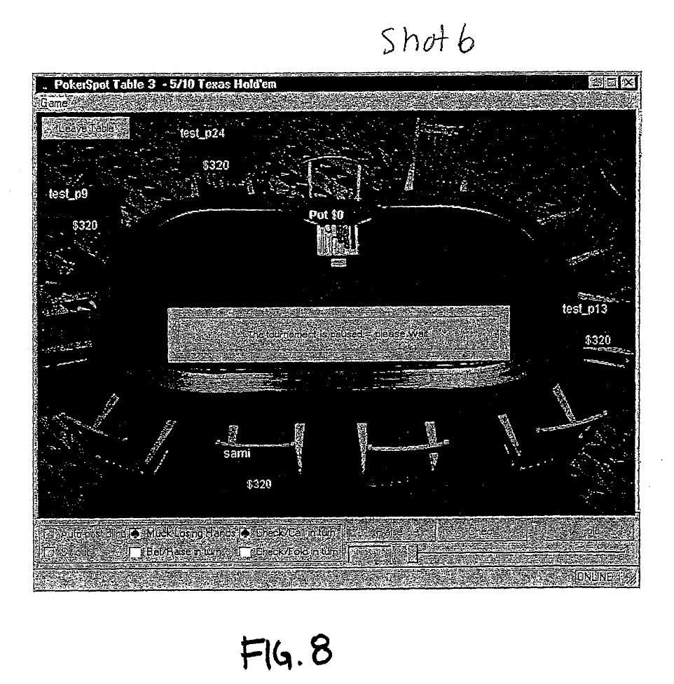

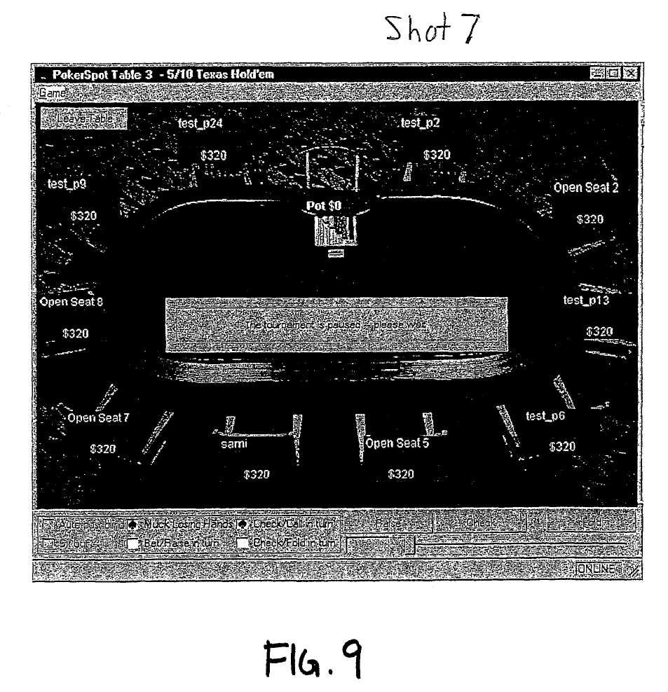

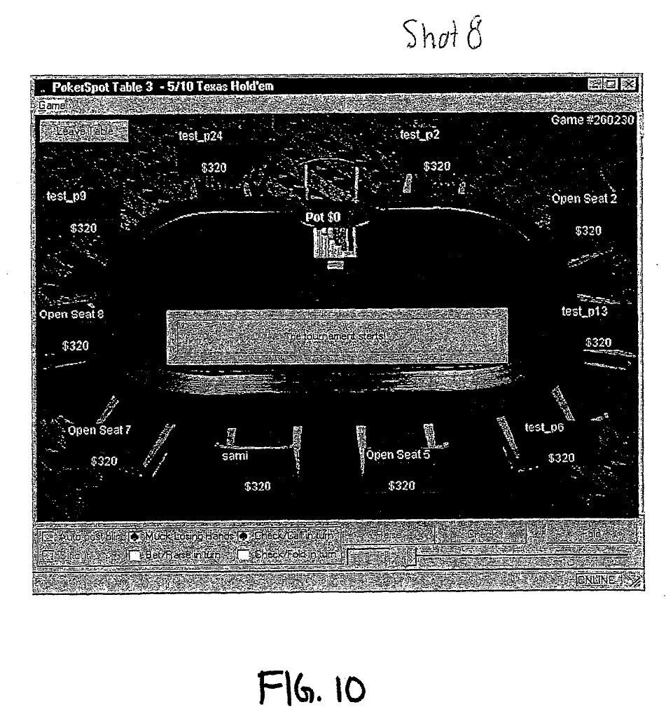

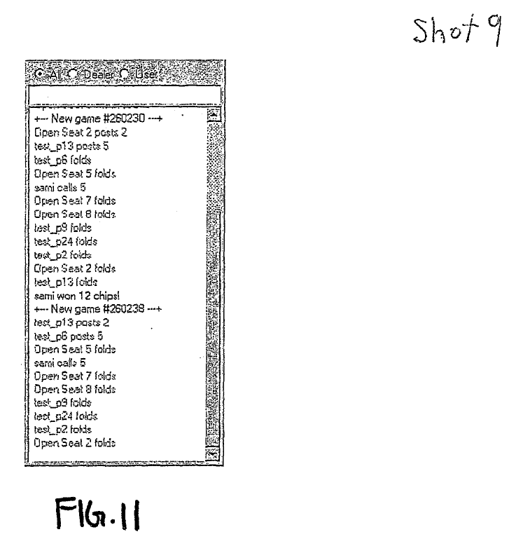

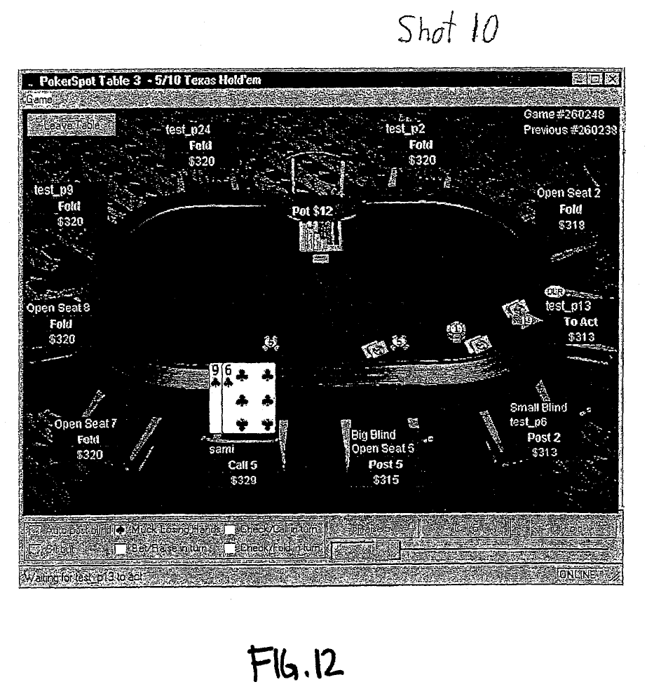

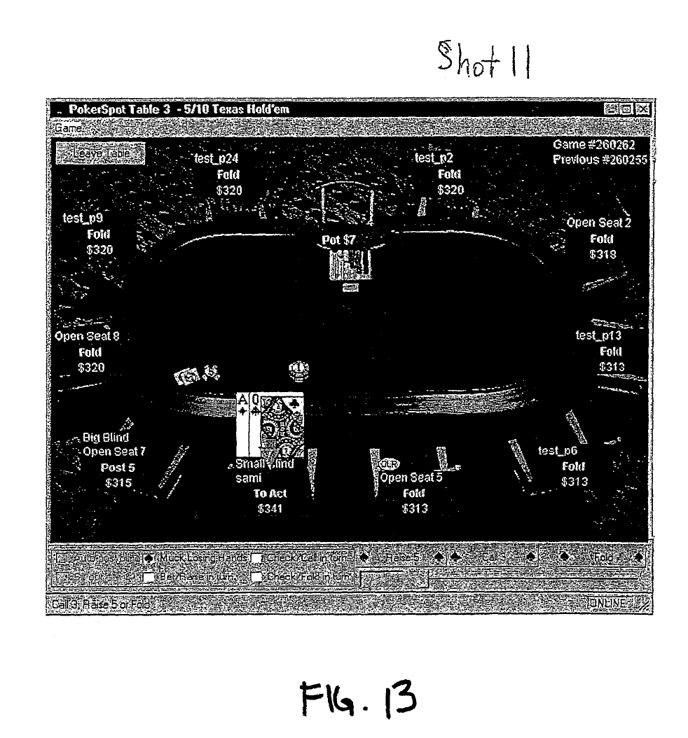

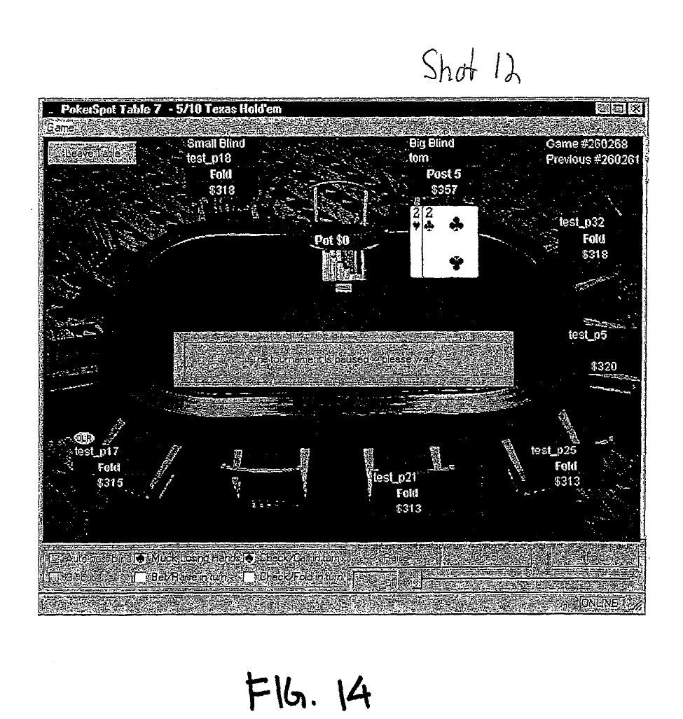

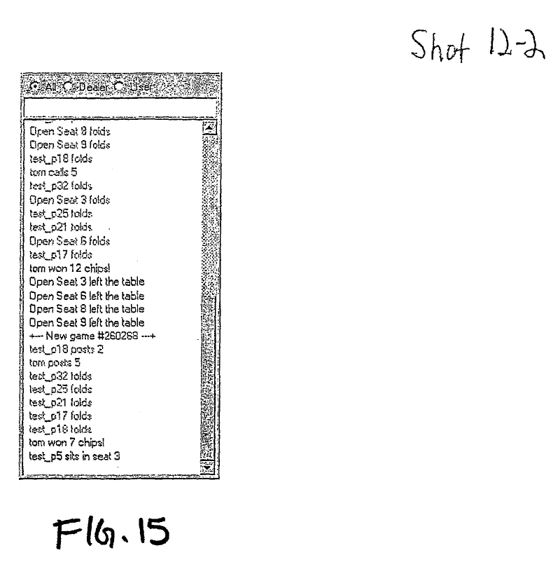

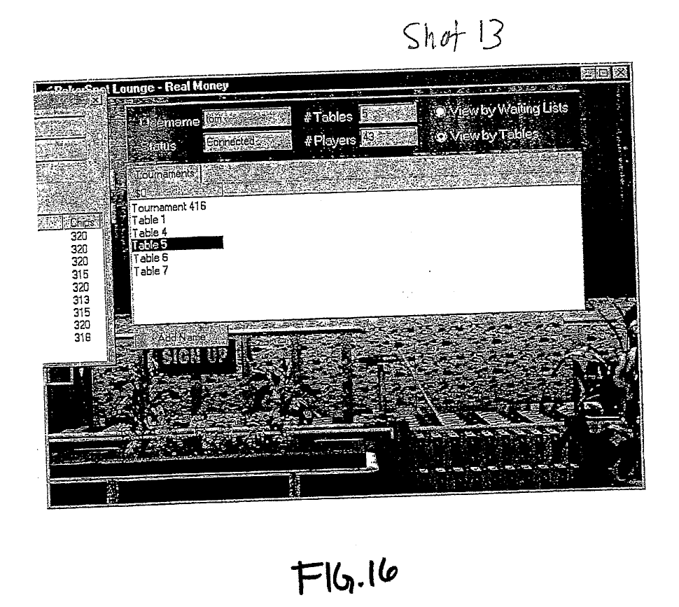

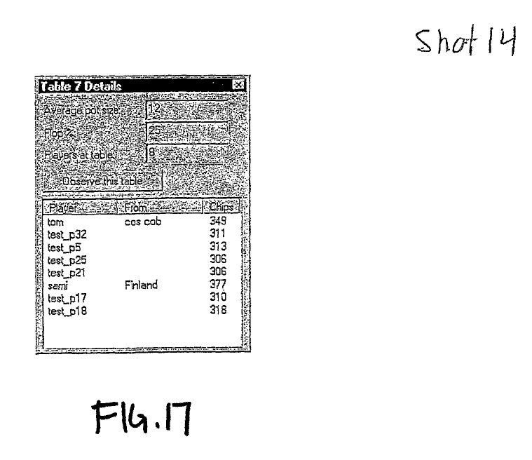

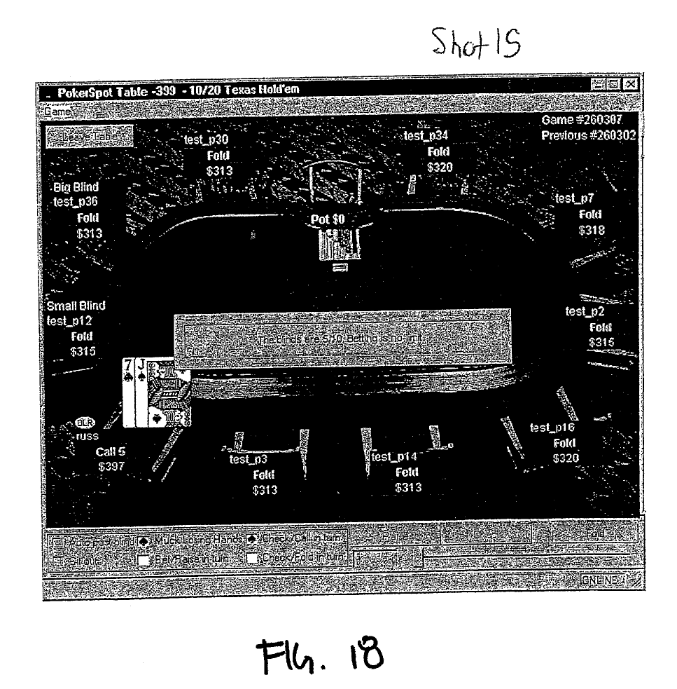

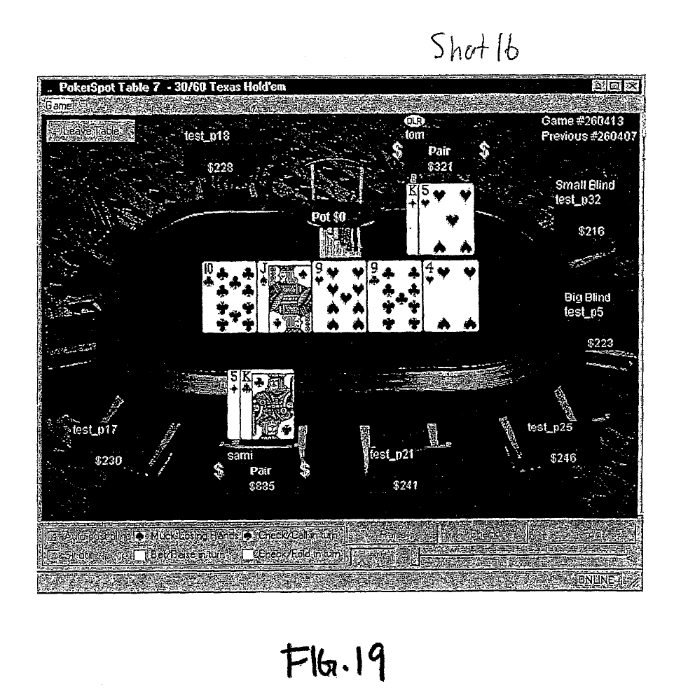

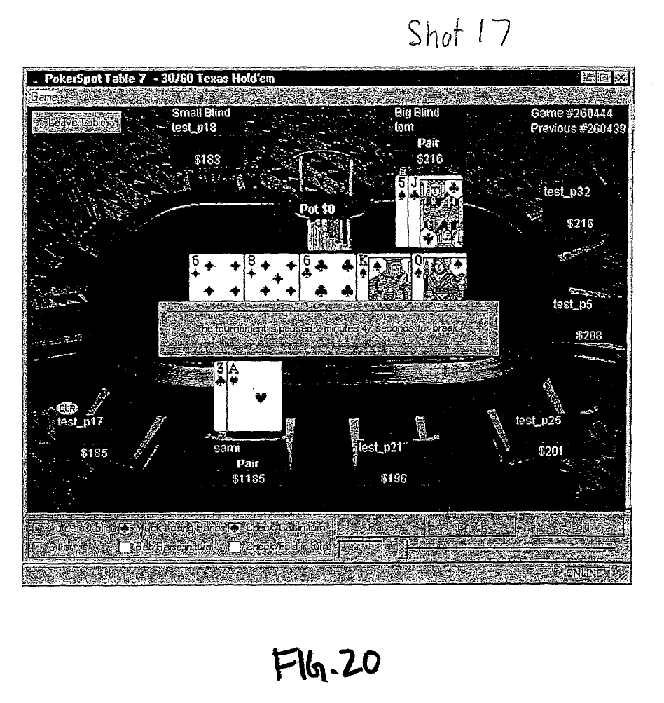

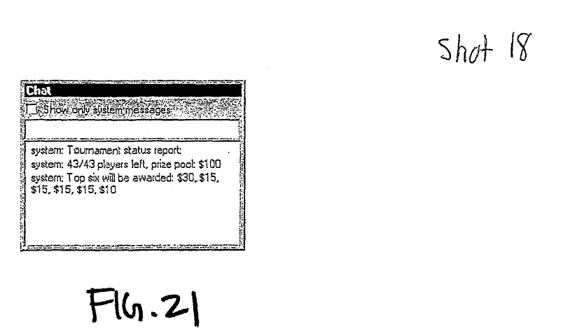

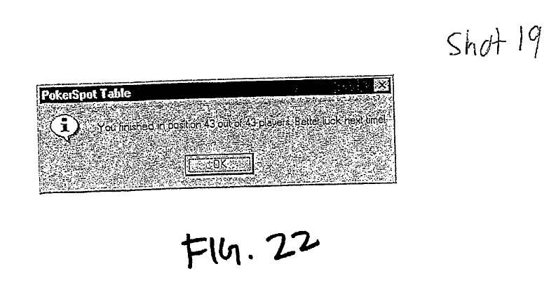

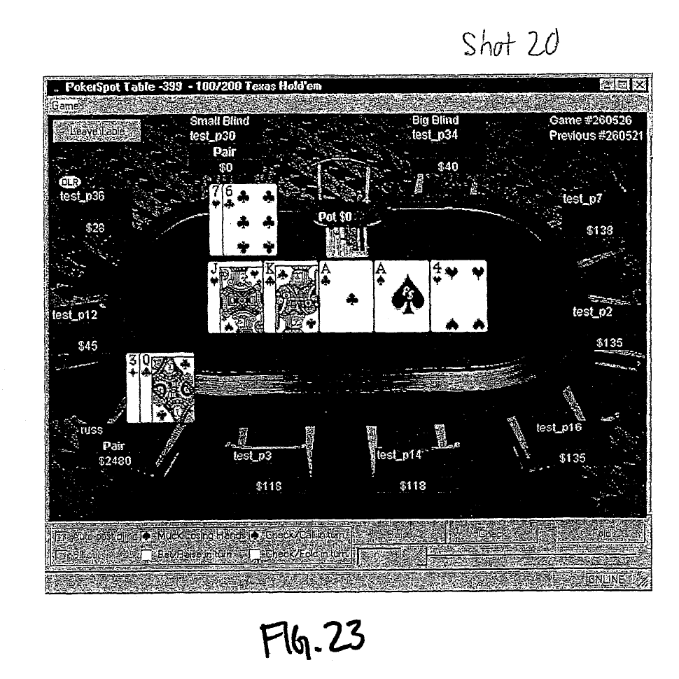

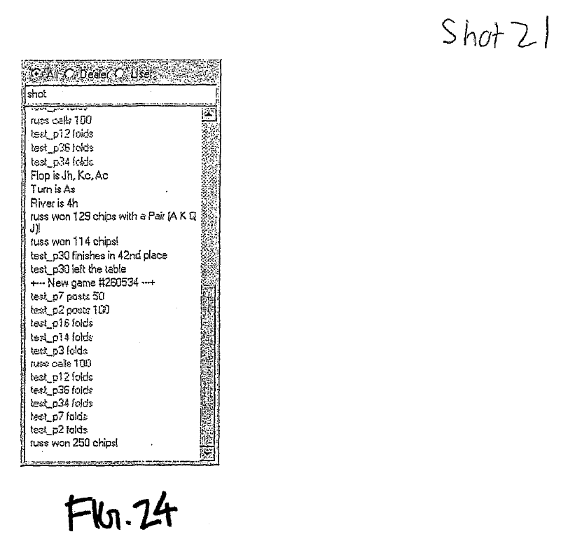

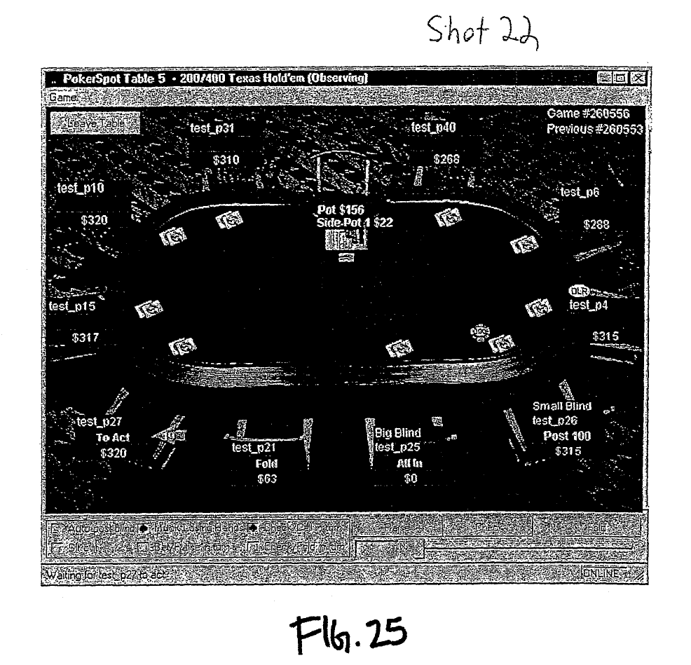

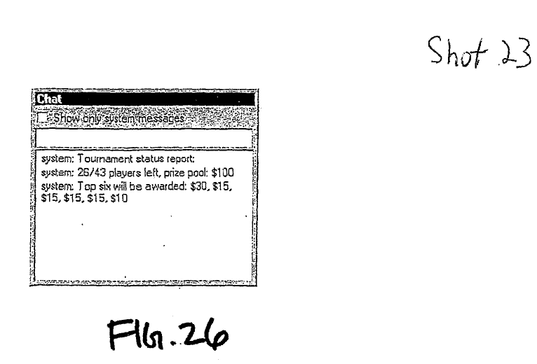

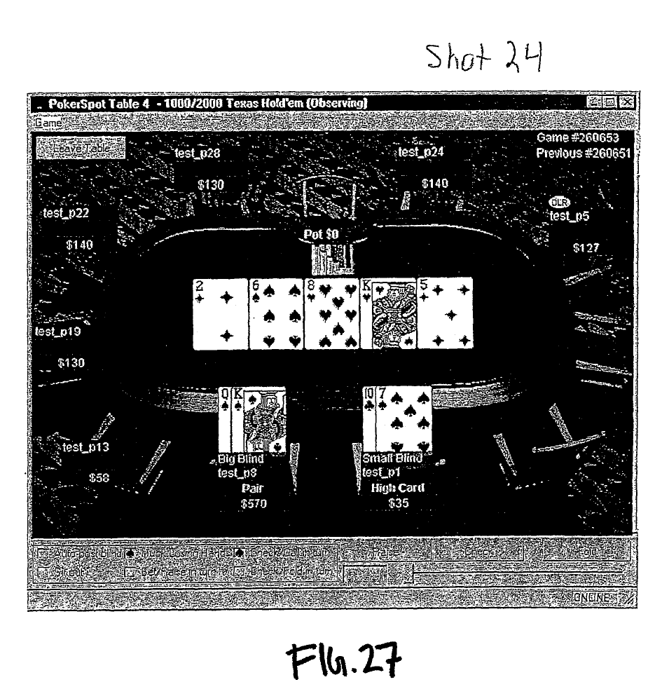

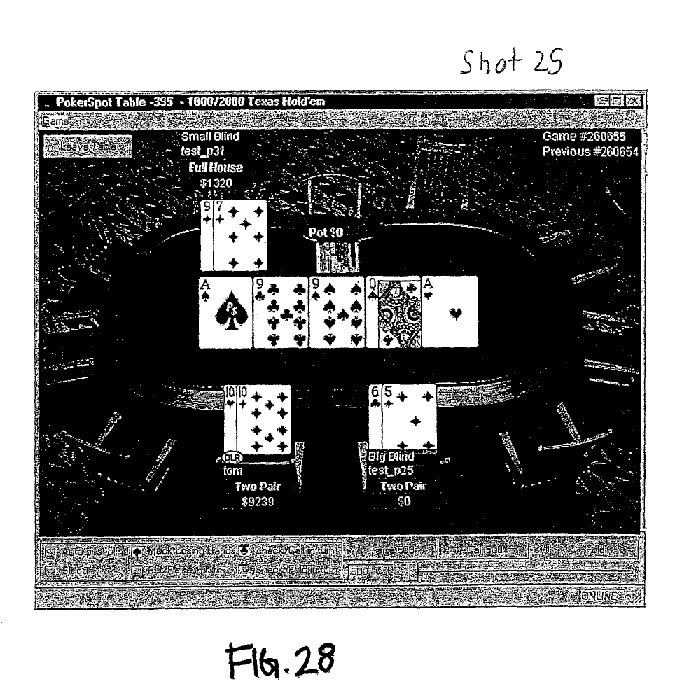

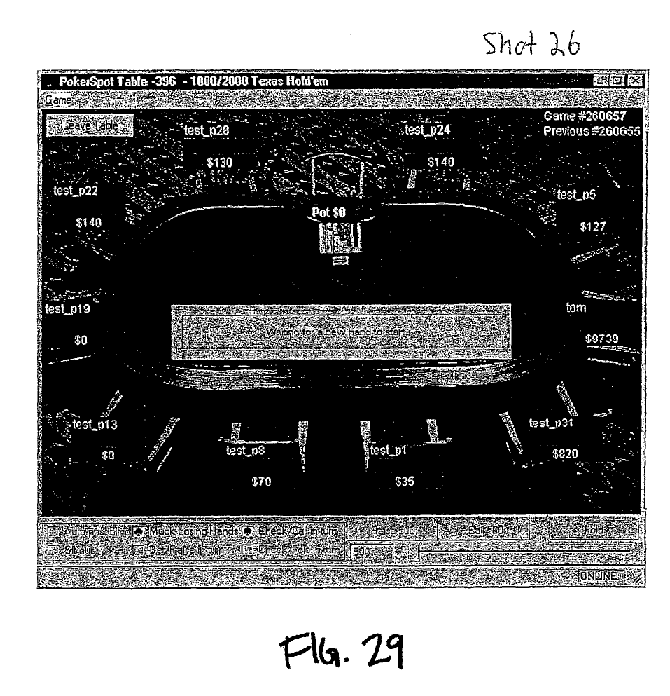

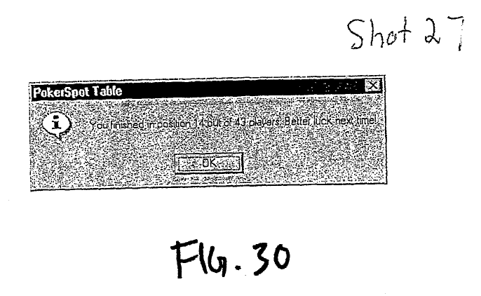

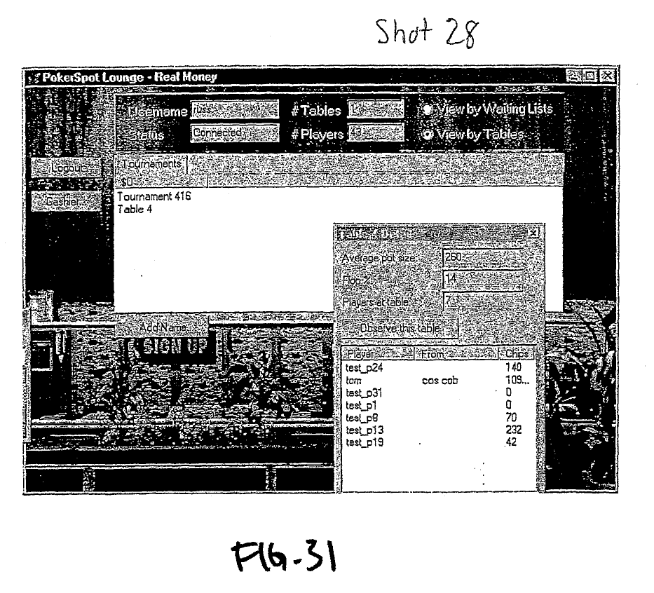

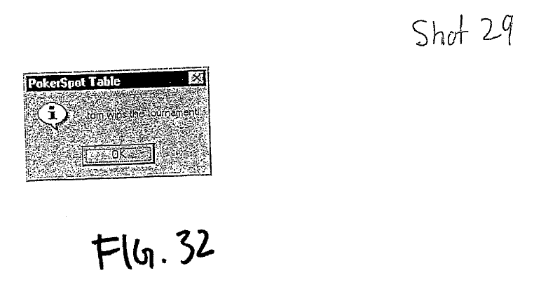

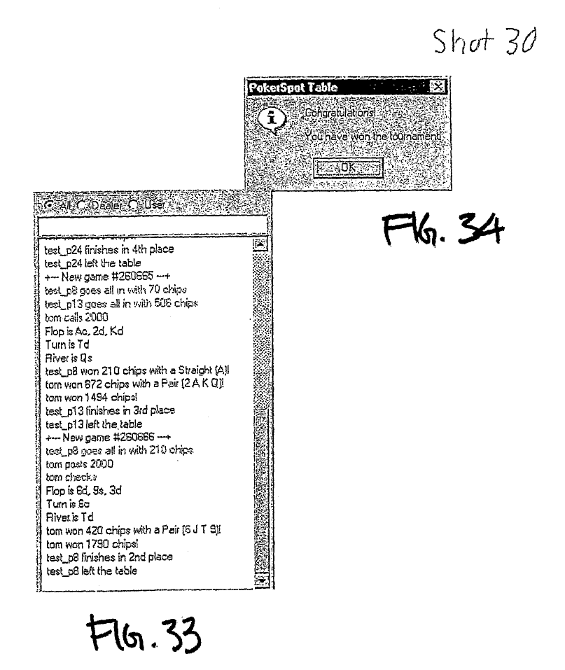

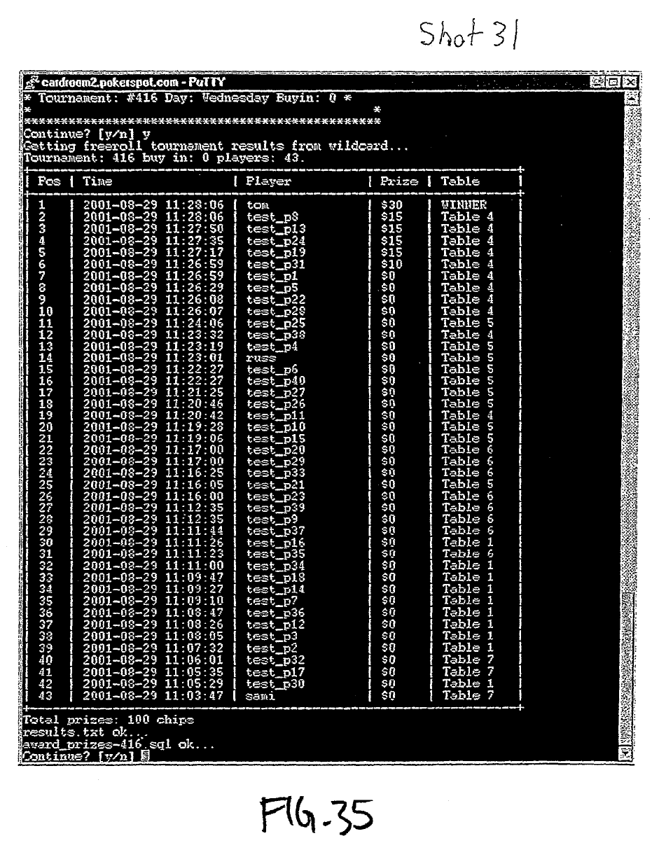

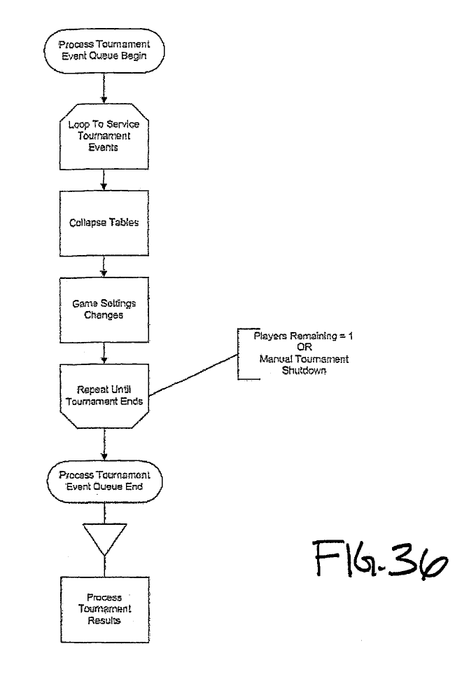

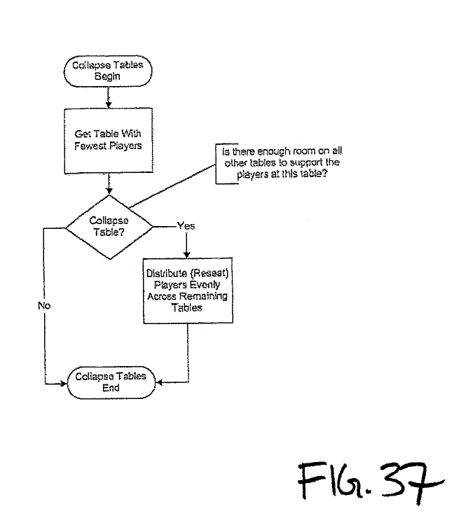

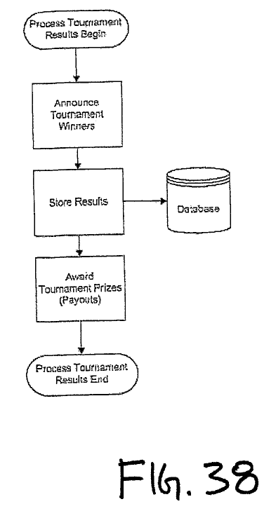

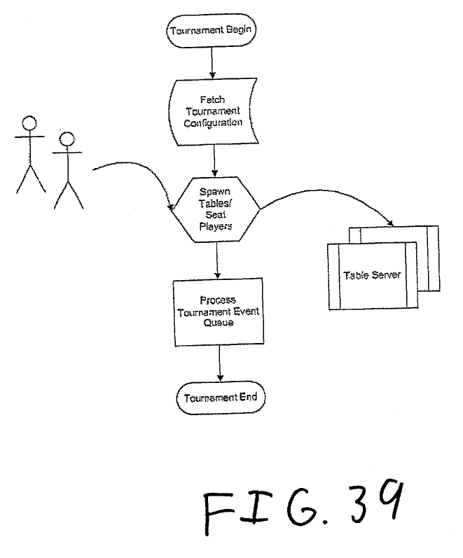

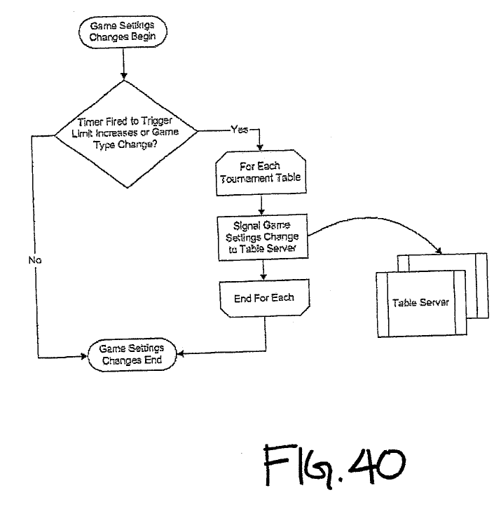

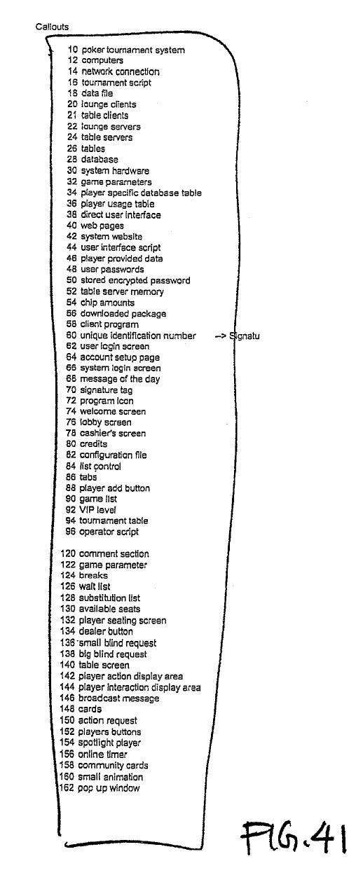

Referring to the drawings, the preferred embodiment of the poker tournament system of the present invention is illustrated and generally indicated as 10 in FIG. 1. As further shown, poker tournament system is embodied in at least a plurality of computers 12 linked by a network 14.

The present invention operates in a networked environment, where two or more computers are connected together so that they are capable of exchanging information. Preferably, the network is the worldwide network commonly referred to as the Internet, but it should also be appreciated that the present system may work inside an intranet such as may be found inside a brick and motor casino.

The present gaming system was created to be flexible enough to adjust to any style of poker. Instead of programming a single style or various styles of poker into the logic of the present invention, the present system reads its tournament settings from a script file and reads its poker rules from a data file. Thus, the system is able to be quite flexible with its changing of gaming rules from game to game as well as during tournaments. Further, the system was created with the intention for use with online tournaments, and an appropriate structure was designed to handle the additional demands required for tournaments over regular ring games that tournaments require.

As the present system was designed for real money, it was essential that the system be secure. Communications between the various clients, servers, and tables in the database are all encrypted. The preferred encryption technique used with the present system is secure socket layers (SSL) on top of TCP/IP. Also, the system was designed so that a minimal amount of data is transmitted between the various clients, servers and database to limit the possibility of an authorized reception by third parties. For example, an individual player's cards are sent only to the intended player and are not broadcast to the other players. Therefore, there is a substantially reduction in the possibility that someone could create an interface that would advise them of other player's hands.

The software system of the present invention consists of various parts including a lounge server, table servers, lounge clients, table clients, and a database. The lounge clients and table clients run on each individual player's personal computer; while the lounge server and table servers run on the system hardware. The features, functions, and construction of these parts are illustrated herein.

The lounge server is a software process that perpetually runs on the system hardware. The functions of the lounge server include orchestrating and managing various tournaments and ring games including the merging of tables and tracking participating players, spawning table servers when appropriate for tournaments, sending and receiving messages to and from the lounge client to receive player input and provide the player with updated information, and reading from and writing to the database to obtain or store necessary information on players, ring games, or tournaments. The lounge server creates table clients and directs them to interact with a particular table server so that a player may participate in a game at a specific table. The lounge server may send messages to table servers to direct the servers to modify game parameters such as changing the type of game or the betting limits of the game.

Each player who wants to participate in the system must have their own lounge client, as players do not directly interact with the lounge server. When a player is ready to participate, he loads up his lounge client. The lounge client automatically connects to the lounge server, as the location of the server is stored within the client. The player may then, using the lounge client, log into the lounge server so that he may participate with this system.

The database of the present invention is a storage structure preferably in SQL format in which information relating to the system is organized and stored. The database consists of two tables, the first of which correlates to the player's user name and contains player specific information such as the player's real name, credit card information, a postal mailing address, and the number of chips (i.e., in real money games dollar credit). The second table relates to the players' recent usage of the system and contains game specific information such as the last five hands that the player has played.

The present also has a direct user interface to the database. Pages on the system's website have interfaces to the database that allows the players to directly add or edit player information stored in the database. The script that receives the data from the interface checks the player provided data to make sure that the input is well formed.

The operator of the system has a means of blocking selective players. When players initially set their password, the password is stored in the database through an encryption routine, such as one-way gate function (e.g., message digest five) that converts the player's plain text password into ciphertext. Players must enter their password when they log into lounge server from their lounge client. The password the player entered is encrypted and compared against the stored encrypted password. Thus, if the operator changes the password, the player's login attempts will fail.

All poker games played on this system are played through the interaction with a table server. The lounge server generates the table server at appropriate times, such as to generate a new ring game or with the initial table spanning in a tournament. Each table server may read and write directly to the database, enabling updates of information including revised chip amounts and the previous hand that a player has played.

During a tournament, each table server runs a series of poker games sequentially at a single table with various players participating. The table server interacts with the players through their table clients. The table server tracks the chips used by players during the games, and this total retained in the memory storage of the table server and is kept separate from the player's true chip amount stored in the database. In tournaments, it is not necessary that the chips be tied to the entry fee (entry fee and buy-in may be referred to interchangeably herein) . Thus, tournament chips may reflect a desirable amount of chips instead of the entry fee.

The lounge server and table servers preferably run on the same computer hardware so that there is no possibility of communication lapse between the two. However, the lounge server and table servers may run on different hardware. However, if the table server was in operation (i.e., had players at the table participating in a game) but could no longer connect to a lounge server, the table server would operate but the game parameters would not change as such parameters are received from the lounge server. The game would essentially run like a typical ring game, with no merging of other tables or other events that occur during the normal course of a tournament. If a table server is created but is never able to connect to the lounge server, then the table server will not be apart of the tournament because nobody will be seated at its table. Scalability problems may occur, however, when the lounge server and the various table servers run on the same hardware as too many processes running on the same machine will detract from the system performance.

While participating in ring games and tournaments, players remain largely unaware of the behind the scenes interaction between the various parts of the system. Players do not see the balancing or merging of tables performed by the table server, but rather only see that that they are re-seated at another table without any allowable player objection.

A person who wishes to participate in a tournament of the present invention must first gain access to the system through a lounge client. The lounge client, while preferably an executable program running on a player's computer, may alternatively be in the form of a java applet or a web-based interface. With the preferred method, the lounge client is first downloaded and then installed by a player from a website maintained by an operator of the system.

The client program, consisting of the lounge client and table client (when spawned) is responsible for all player interaction with the networked gaming system of the present invention, and the player never directly interacts with the servers of the present system. Thereby, there is an extra level of security in the limited functionality that the software used by the player may have with the present system.

The client program is preferably implemented in C++ and is designed to run on a personal computer running the Windows operating system. The system servers, consisting of the lounge server and table server, are implemented in C++ and currently run under Free BSD UNIX and Windows NT.

The lounge client is a basic software program that runs on a personal computer of a player. The lounge client provides a window user interface that allows players to log in to the lounge server and interact with table servers as is appropriate. The lounge client does not have much functionality, but rather simply provides a communication means for interacting with the various servers generated by the system. The table servers conduct the various games and each player's table only receives information that it should be privy to. Thus, the client is so minimal that there is really nothing for a hacker to infiltrate. The client was created minimal for security reasons.

The client program provides the means for players to interface the system. Before the player may used the client program, he must first download and install it. The client program is packaged in a ZIP file and located at the system's website web server. The downloadable packaged contains the lounge client, the table client executables and a few Microsoft library modules in case the player's version of Windows is outdated. The install program is install shield and it appropriately creates various directors and places files within the directories. A shortcut appears on the player's display for ease of accessing the client program.

When the player logins using the lounge client, the lounge server identifies the version of the client program. If the lounge server determines that the client program is out of date, then the lounge server initiates a download by sending to the player's computer an updated version of the client program and installing it. The player must then restart the client program to make another attempt to use the system.

The system determines when the player is using an incorrect or modified version of the client. When a player logs in with his lounge client, the client sends a check sum to the lounge server that is computed out of the player's executables and compares it to an expected value stored in the database. If the received check sum does not match the expected check sum, the lounge server believes that the lounge client version is improper and the system forces a version update.

There is a unique identification number that is generated for each player's computer that acts like an Internet “cookie”. The identification number is created when the player logs in for the first time. Thereafter, when anybody logs into the system from the same computer, the same identification number is sent to the lounge server. The database maintains a list of user names and identification numbers, allowing the system to know whether there are two or more users using the same computer.

The identification is not the primary means of determining whether a player is unfairly using more than one user name during a tournament. Rather, the lounge server checks the IP addresses of each player's computer to make sure that no two IP addresses are identical.

Every time a player launches his client program, the player is presented with a login screen on his display that prompts him for his user name and password. The login process is to insure the person requesting access under a particular player's account is that player. The player, under the preferred method, creates a user name and password when he creates an account with system. The system account is a prerequisite to the player's use of the system, as the player is taken to the account setup page before he is able to download the client program. On the setup page, the player is required to create an account and disclose his name, address, and credit card information. The disclosed information is stored in the player's table in the database.

The first screen that the player sees upon launching the client program is the login screen. Once the player is authenticated and is logged in, a message of the day is displayed which describes events and other important messages that the operator wishes the player to know of. Immediately thereafter, the lounge client is fully operational and a list of games and tournaments appear in which the player can participate. The player may review the game list in his interface on the lounge client and may then choose the game(s) (i.e., ring game or tournament) in which he wishes to participate.

Once the software is downloaded and immediately after the player creates his account, a signature tag is stored on the player's computer to identify the particular player's computer. The signature tag allows the system to track the computer from which the client program has been launched. The signature is stored both on the player's side and on the server side in a table of the database that corresponds to the particular player. Thus, the system is able to determine when more than one account has been established from a single computer. The signature assists in the recognition of possible simultaneous entries by the same player in a tournament.

When a player wishes to play, he double clicks the program's icon to launch the lounge client program. The lounge server authenticates the player's password, and checks to see whether the player has already logged in. As the lounge client initially connects to the lounge server, it passes the user name and password to the lounge server. The lounge server checks the database to determine whether the user name and password match someone already known by the system. If they do not match, the lounge server sends a reject notification to the lounge client and the player is allowed an additional opportunity to login. If after 2 times the player was not successful with his login attempts, the lounge server will disconnect and close the lounge client. On the other hand, if the server determines that the player has already logged in, the server sends an error message to the user and telling him that he is already logged in and will thereupon log him out of the system. After the initial login steps and verification, the lounge server broadcasts a message to the lounge client the effect of which displays a welcome screen that is displayed for 2-3 seconds.

From the lobby screen on the lounge client, players have access to the cashier's screen. The cashier's screen shows how many credits the player has in his account. Under the present invention, the credits are in the form of currency of the United States. However, it should be appreciated that the credits can take the form of other currencies, or redemption points usable towards prizes.

The operator creates a human readable configuration file to advise players of the available tournaments. The configuration file is created by the operator and should correspond to the tournament created by the operator. The configuration file is a plain text file that contains the waiting lists for tournaments. The lounge server reads in configuration file, so that the player's lounge client will display the updated list of available tournaments whenever a user logs in. The lounge server re-reads the configuration file every five minutes so that all players logged in will have up-to-date information.

The lounge client has a list control that provides the players with a list of all the scheduled and ongoing tournaments and ring games on the system. The list control has a series of tabs that correspond to the various games. The list control also has another level of tabs that corresponded to the antes and limits for each game. If the player wants to participate in a ring game, he must click on the appropriate tab and add himself to an existing table or join a wait list. Anytime there are two or more players for a particular game, a new table will spawn so that they players may begin playing against each other.

There are also separate tabs for each tournament. When the player clicks on the tab of a particular tournament, he may view the description of the tournament the operator entered in the configuration file. There is also another button that the player may click to add his name to the list of players scheduled to play in the tournament. Once the player is added to the list, other players may now see that he has been added to the list of players scheduled to participate in the tournament.

When tournaments are created, they are listed on the game list. The game list is generated on the system side, and it defines the games and tournaments that are available to the various players. When a user clicks on a tournament in the game list, the player may review the attributes of a specific tournament. Thereby, the player can decide whether he wants to participate in a particular tournament.

Before players may be added to the list to participate in a tournament, information is first verified, specifically the player must have (i) been authenticated on log in, (ii) sufficient credit to enter the tournament, and (iii) a high enough VIP level (when required). Thereafter, so long as the player does not close his client or remove himself from the wait list, the player is guaranteed a seat when the tournament starts.

The available tournaments are listed for the player on the lounge client. Each has a unique integer, and the integer corresponds to a unique tournament number. Players, by clicking on a tournament number, may review the attributes of any selected tournament. The information contained in the attributes include the start time of the tournament, they type of game(s) to be played, betting limits, increased times, scheduled break(s), and any other changes to the tournament. The player may also view the number of other players who have signed up for the tournament as well as their player names.

An operator of the system, among other tasks, is responsible for creating and running the various tournaments. Players are not permitted to create or formally request a tournament. Instead, tournaments are generated exclusively by the system through the creation of a script by an operator. While player of the present invention could be permitted to create their own tournaments, such ability would give the individual players too much control and power over the system.

The operator needs access to a computer with network access to interface with the present system as the lounge server and database run off of a hardware server. For the operator to access the table server and database, he will preferably interact with the system software via telnet access into the server so that he may interact directly with the command line of the system software. The preferred operating system of the system software runs is a Free BSD, a type of UNIX, which the operator interacts with from a UNIX shell.

When the operator wishes to create a new tournament, he must first decide what type of tournament he wishes to create and when he wishes for it to run. After doing so, the operator telenets into the operating system of the system hardware and is provided with a UNIX shell to the system. The operator may then create a script to reflect the type of tournament he wishes to run, and stores the script file in a specified directory on the system hardware. The operator then edits information in the tournament table of the database through a further script. The fields modified by this script include the tournament start time, the maximum number of players, a description, the required VIP level, the unique integer that is used to differentiate the various tournaments and the location of where the tournament script file may be found. The operator presently manually creates the description of the new tournaments provided in the script above. It will be appreciate that a separate program could interpret tournament script and auto generate the description. The system of the present invention then becomes aware of the added information through the modification of a flag in the database that the lounge server constantly polls. The lounge server polls the database every 20 seconds or so, and once the lounge server is aware of the modification, it reads the information from the database and presents it on the system so that players may review the information about the pending tournament.

The operator is responsible for creating the tournament script (also referred to interchangeably herein as “poker script”) that is used by the lounge server to generate the tournament. The tournament script defines the type of game and betting structures and was created for flexibility by providing game changes during tournament play. The tournament script is in the form of a human readable text file and is preferably located in a directory on the same hardware where the lounge server is running. The lounge server only reads the tournament script once the start time has been reached, and thereupon makes a copy of the tournament script in its memory for use. Thereafter, any change to the tournament script by the operator after the tournament script has been read will not affect the tournament game.

The tournament script provides the ability to change the betting structure and game type during the course of the tournament at various offsets of the tournament start time. To create a tournament, the operator defines a tournament script in a specific directory. The tournament scripts allows the play of tournament games to be very flexible. Turing to SCRIPT 1, it may be observed an optional comment section for which the first line consists of the beginning of a comment in standard C format (i.e., “/*”), in which the ending of the comment may be found on the seventh line (i.e., “*/”) , The description contained within the comment section on lines two through six provide a reader of the script with information about how the script functions.

Viewing the 8^{th} line of tournament script, in human readable form the first substantive line of the tournament script describes the initial game type of the tournament. The game parameter is interpreted by the table server and it will proceed with the game according to the define rules of the specified game of poker.

When the lounge server acts on line 9, it broadcasts a message to the various table servers to suspend action for two minutes. One minute after the suspension is lifted, line 10 provides that the betting during the current poker game (i.e., Holdem) is no limit. Twenty minutes later, line 11 provides that the blinds and limits will raise to 10. Twenty minutes later, line 12 provides that the blinds and limits will raise to 20. An additional twenty minutes later line 13 provides that the blinds and limits will raise to 30. Twenty minutes later, line 14 provides that they users are given a five minute break by the “pause 5” command.

Immediately after the break, line 15 provides that the game type changes to Omaha. One minute after the game type changes to Omaha, line 16 provides that the blinds and limits are risen to 50. Twenty minutes later, line 17 provides that the blinds and limits are risen to 100. Another twenty minutes later, line 18 provides that the blinds and limits are risen to 200. Another twenty minutes later, line 19 provides that the blinds and limits are risen to 300. After an additional fifty minutes, line 20 provides that the game has a second break of five minutes. Immediately after the second break, line 21 provides that the game type becomes Holdem again. One minute later, line 22 provides that the blinds and limits raise to 500. Twenty minutes later, line 23 provides that the blinds and limits raise to 1000. An additional twenty minutes later, line 24 provides that the blinds and limits raise to 2000. An additional twenty minutes later, line 25 provides that the blinds and limits raise to 3000. An additional twenty minutes later, line 26 provides that the blinds and limits raise to 5000. An additional twenty minutes later, line 27 (i.e., the last line) provides that the blinds and limits raise to 6000. The tournament concludes under the current game type and level of limits and blinds.

Breaks are defined in the tournament script at various times. At 20 minutes pause five minutes. The lounge server sends a message to all table servers to pause the play for a specified period of time. The table server will complete the ongoing hand and will then cease to deal further cards or engage in further play until it receives another message from lounge server that it should continue with its games.

The table server handles and directs the vast majority of the functionality of a dealer and card table. When the table server desires a response from a player, it sends an action request to the particular player's lounge client. In the action request package, identifies the player who is to interact. The table client is receptive to the action request and displays the graphics and/or text to inform the user of the request input as well as enables the player's table client to provide such input. It thereby enables relevant player buttons so that the player can raise, call, or fold. The player may then click one of the buttons, and then the table client sends the response to the table server. The table server echoes the response to the rest of the players at the same table, and their graphics and/or text is update to reflect the response.

The information sent to players during the course of a hand most of the time only updates the current state of the play, and does not provide the player with a complete refresh of the status of the table. This provides a means to reduce the amount of information that is sent back and forth over the system. However, the beginning of every hand is a complete refresh of the table.

Sometimes the number of player permitted to participate in a tournament are limited. In the current embodiment of the system, there is no alternate list (beyond the original wait list) for players who did not add their name to the wait list before it was filled. Preferably, however, the system uses an alternate list that provides for substitutions for situations in which a player from the wait list fails to join the tournament at the appropriate time and the substitute player is inserted in their place.

When tournaments have been scheduled, each player's lounge client will display them. The player, upon reviewing the list, may click on the add name button and thereupon the lounge client will send a message to the lounge server to add the player's name to the wait list. The wait list is a simple list structure in the process of the lounge server.

The player may use his lounge client to view the various tournaments on his display, and he may choose to add himself to the wait list of a particular tournament. When he does so, the server checks the availability of an opening on the list. If there is an open slot, the lounge server will check to make sure that the player has enough money available. However, no chips are subtracted from the players account when he adds his name to the list, but rather the chips are subtracted when he is first seated at a table. If the player does not have enough chips when he is seated, he will receive notice that he does not sufficient chips to enter the tournament and his participation is cancelled. Players who have joined the wait list can participate in other ring games until start time.

Tournaments are scheduled to begin at the specified start time indicated in the database. The start time is inserted into the database generally after the tournament script is generated and stored in the appropriate directory on the system. However, tournaments alternatively may be auto-scheduled on regularly scheduled days or may be scheduled to begin when a certain amount of players are on the waiting list. Preferably, tournaments are manually scheduled by the operator to provide an extra level of scrutiny. While the system is capable of having regular tournaments on a daily or weekly basis, under the present invention it is preferably to have scripts create the desired tournaments.

A few minutes before a particular tournament is to begin, the lounge server reads the list of players who have indicated that they want to participate by placing their name on the wait list, and broadcasts a message to the player's respective lounge clients reminding them of the start time of the upcoming tournament. The lounge server also broadcasts a message to other players connected into the system and provides them with the tournament information and allows these players to add themselves to wait list if there are any open seats. If a player wants to add his name to the wait list and participate in the tournament, he may be added by clicking on the add name button. The player's addition is relayed from the lounge client to the lounge client, and that player's addition is broadcast to the other tournament participants. This process of adding additional tournament participants continues until the tournaments starts.

Once the start time is reached for a particular tournament, the lounge server spawns various table servers depending on the number of players participating and the number of available seats at a table (e.g., 10). The lounge server the randomly assigns the players to the various tables by creating a table client for the player that only interacts with the specified table server. During this process, the player is presented with a screen that indicates that are presently being seated. After all the players are seated, the tournament can begin.

Players must be seated at tables to participate in the tournament. The present system has a means for randomizing the players seating at the various tournament tables. The lounge server takes the first name from the wait list and then seats them at a random table. The lounge server then flags that it has already seated one player at that particular table, and will not seat another random player at that table until all other tables have been flagged. Thereafter, the lounge server clears the flags and continues to randomly seat players at the various tables.

Before the table server starts providing cards for the players hands it uses an algorithm for a random sequence it shuffles the fifty two card deck. Thereafter, the player in the first seat receives the dealer button. The process of providing the deal button is random, because the players are seated randomly at the various tables. After providing the player with the dealer button, the table server broadcasts a message to its players that the selected player has the button. Each player's display is refreshed to indicate that the chosen player's seat is shown with a dealer button. Following the showdown, the next hand begins with providing the next player with a dealer button.

After the table server assigns the dealer button, the table server broadcasts a small blind request that is sent to all players. The request contains an integer that identifies the player who is to be the small blind and is generally the player next to button. Players cannot avoid becoming the blind as to do so would inhibit the table server's ability to collect an ante. The player's table client responds to the request and accepts that it will post the blind, while the other players' table clients do not reply. When the table server receives the reply, the server broadcasts to all players as to who is the player who will post the small blind. Each player's lounge client visualizes the process of the specified player giving the chips constituting the small blind. After the process of assigning the small blind completes, nearly the same process occurs for the big blind request.

Once a player is seated at a table, the player uses his table client to participate in the games of the tournament. The player is presented with an additional screen, referred to herein as a table screen, which resembles the view of a player when sitting down to participate in a game of poker and a brick and motor casino. Part of the table screen provides an interface for interacting with the table server (i.e., participating in a game) a display area to demonstrate to the player the actions taking place during the various games, and an interaction area where players can chat with other players at their table. While the player remains at the table, he may receive messages and updates about the tournament from the system and/or dealer.

As the player arrives to be seated at the table, the table screen will appear on his display and the player's username will appear over his seats at the table. As players are seated, a message appears on their table screen to advise them that they other players are still being seated and to please wait. Once all players are seated at all of the various tables, there is a short break (i.e., 1-2 minutes) before the tournament starts. The server waits the extra few minutes to ensure that all those who have a slow connection have extra time to log in (when the table client logs into the table server

Generally, players use tournament chips and not real money in tournaments. The number of tournament chips is a parameter in the database that the operator defined for the specific tournament when he created it. The lounge server reads the tournament chips to be given and passes the information to the table servers when they are spawned.

Thereupon, the table server credits each player with a certain amount of chips and tracks the players chip count during play. In ring games, the player is prompted for the amount of chips he wants to bring to a table. The player indicates the amount of chips (e.g., $50), and the amount of chips is subtracted from the player account.

Following the short break, the tournament starts. If there are less than a set number of participants (e.g. 3 players), the system may elect to cancel the tournament. If there is not cancellation, the table server decides (for games where it is appropriate) who will have the dealer button player and who will be the big and small blind. The lounge server then sends a broadcast message to the various table servers regarding the initial betting limits. The table servers then provide notice to the players of the initial limits. During the course of a tournament, any time the limits or rules are changed, the lounge server first transmits the message to the table servers, which then relay the information to the players through their lounge client.

While the tournament is running, the player interacts directly with the table client through use of an input device as a keyboard or mouse with the interface on the table client. The lobby client will continue to run in the background during the tournament. If the player views the lobby screen of the lounge client during a tournament, he may view statistics about the tournament such as the amount of players left or, by clicking on other tables, he may load another tables screen and view their actions such as the chips left and who is presently winning the various hands. Thereby, he may track the performance of other players during the tournament in real time.

After an ante, the players are dealt cards in accordance with the game they are playing. Therefore, if the game is Texas Hold 'em, each player will receive his first two cards face down. When the action on the table gets around to him, using the interface of the lounge client the player's buttons will become enabled and the player will be able to fold, call, check (if no bet), or raise. If the player decides to raise the bet, he may use either a scroll bar or keyboard entry to enter the amount of his raise.

When the action comes to a specific player, the table server broadcasts an action request that identifies who is the spotlight player (i.e., the player whose turn it is to act). The broadcast message, as received by the specified player, enables the player's buttons so that the player may take action such as allowing the player to raise, fold, or call. All the other players may observe that the particular player is the spotlight player and his action is currently pending.

After a player receives an action request and his lounge client notifies him that such a request has been received, the table server will wait 20 seconds to receive a response before proceeding with the default action. If no timely action request is received, the system takes the default action by folding the player's hand. Players receive an online timer when they are the spotlight player with a time limit to act. The table server initiates a timer that is triggered on the selected player's table client that the player has a limited time to act. The table client generates indicia of the wait time, which preferably is an arrow pointing to the player indicating the time remaining.

Then action continues so that the table server sends the same action request to the next player. This goes on through the table until it hits the big blind again. At which point, the betting round is considered complete unless somebody raises the bet in which the action continues as would at a standard brick and motor casino.

After the first betting round is over, the table server sends a broadcast message to the table clients identifying the community cards that should appear on the table presented on the player's display. After the players have received the message, the table server will send another action request message to identify the next player to act. Whenever it is a particular player's turn to act, the table server broadcasts a message and the buttons enable for that person on its screen. The reply is transmitted to the table server, and then the table server echoes the information back to all of the players.

At the times indicated in the tournament script, players will receive a break. The lounge server broadcasts a message to the various table servers and advises them at the end of the ongoing hand, to delay dealing further hands for an additional period of time. The table server, after completion of its hand, broadcasts a message to the various table clients attached to its table. The message, when received by each player's lounge client, spawns a count down clock to track the amount of time the player has left during the break

The table server when it has a set of players that are in the show down determines who has the best hand. The table server uses a subroutine to compare the hands to determine which player has the best hand. After the table server determines who is the winner, the server sends the show down completion broadcast message identifying which player is the winner and how many chips he has won. The broadcast message also triggers a small animation on all players' table clients that shows dollar signs next to the winner so that all the players will know who has won. Thereafter there is a five second break so that players may view the winning player's cards and compare it to their own so that they may verify that the winner had in fact had a better hand then they did.

When the players are first seated at the table, the lounge server subtracts the buy in cost of the tournament from the player's account that is stored in the database. (At the time when the player adds himself to the waiting list, the software only checked to make sure the player has enough money available in the account.) Ring games vary from tournament games in that ring games always starts with players buying in.

Once the player has completed his play in the tournament and he has either lost all his chips or won the tournament, a pop up window appears on the player's display to either congratulation him on his victory or to advise him of his position with respect to the total number of players entered along with wishing him better luck next tournament. Participants who placed high enough in the tournament to receive a prize will receive an e-mail message indicating the prize that they have won along with congratulations.

There may be an incentive for players to participate slowly in a tournament. However, the system provides a limited time (i.e., 20 seconds) for the player to act. When it is the player's turn to act, a running timer appears over the indicated player's name. If the player does not act, then the default action is taken and his hand is folded. In the real world, if a player delays the tournament to give him an unfair advantage, he is first warned and then kicked out of the tournament. The system may alternatively use a first warning and second kick out scheme, which it would then provide by pop up window. However, it is preferred to have an automated process of defaulting so that the hands move along smoothly and with less player complaints.

When a player's table client is disconnected, the table server still maintains the player's seat at a table. When the player is able to restore the table client connection, the lounge server keeps track of where the player should be and generates a new table cable for the player that corresponds with his table. During the player's absence, the table server will fold the player's hand every time. Thus, players may return tournament to a tournament even if they have been accidentally knocked out.

As players are eliminated during the tournaments, various tables are merged together to reduce the amount of excess tables needed. Table merging is standard for tournaments that occur in brick and motor casinos. However, merging tables in the cyber world is more complicated because it involves the system tracking various tables and players acting independently.

The lounge server tracks the number of players in a particular tournament. When a threshold has been crossed, the lounge server knows that it must merger one of the tables. The threshold used to merge the tables is when if one table were removed, then the total number of players would still fit in the open seats existing at the remaining tables. Once the threshold is crossed, the lounge server sends a broadcast merge message to the table server with the fewest number of players remaining. The merge message instructs the table server (i) to cease dealing to the players after the particular hand. These actions result in the players at the merging table to receive a message that says they will be reseated in a moment . . . Please wait. The lounge server takes the names of the players at that table and randomly assigns them to the rest of the tables. The table server then proceeds to send the player to the specified table and to provide the chip count of that player at the new table. After the ongoing hand finishes at the new table server for which the player is being placed, the player's table client connects to the new table server.

Once there are only two tables left in the tournament, in the preferred embodiment of the system each table server would run its hands simultaneously and would wait for the other table to finish its hand before beginning the next. Therefore, players will not be able to improve their position in the tournament by delaying the tournament.

When the last player is eliminated and there is only one player left who has all the chips, the tournament is over and the remaining player is the winner. The lounge server will be award the only one player is left as it knows at all times how many players are in the tournament. The lounge server will announce to the table server that the tournament is over. The winning player of the tournament receives a pop up window with special congratulations.

When a player wins a tournament or places high enough that he is awarded a prize, the credit will be issued directly to his account. The operator runs a script that reads the logs from the database and generates a human readable report with players position, name, report, and amount of prize pool he should be receiving. Upon appropriately clicking, the operator runs a separate script that directly modifies the player's database to increase the amount of the credit that they have (i.e., thereby awarding the prize).

If the tournament was a benefit tournament or for a prize (as opposed to a real money tournament), the players who were awarded prizes may go to the cashier's screen on the lounge client and choose the prize or charity. The cashier's screen may optionally contain a means of generating additional user credit; such as by viewing banner click ads provides more credit for play. Thereupon, prizes relating to the advertisers may be given to winning players who wish to cash out.

During tournament play, the system logs every hand and every action. Thus, every time a player is seated, they are dealt cards, or an action occurs (bets, hand, wins, etc), the information is stored in a hand log relative to the table at which the play occurred. The actions taken in the tournament itself, such as tables merging, players exiting, game type changing are recorded in a separate tournament log file. All entries into the logs are time stamped.

One of the primary reasons for logging is that it provides information that is used for reporting process. The reporting process is thus able to determine information such as the type of tournament and who won the tournament. The information obtained from the logs may effect the VIP level, the distribution of prizes, and the sending of e-mails to those who have been awarded prizes.

Another reason for logging is that it provides a means to review exactly what happened during the tournament. Typically, when a player believes that something wrong has occurred, they player within a few days of the occurrence will complain to the ha customer server department by e-mail. When the player questions about a specific occurrence in the tournament, a customer service representative may review the log file to determine what happened. Upon review, the customer service representative may compensate the player if their was an error in the system, or, if there was no error, the customer service representative may advise the player of what happened and can optionally generate a graphic to show the player what the status of the table was at the time he believed the error occurred.

The operator, upon logging in to the lounge server, can view the tournament screen to determine when the tournament finishes. After the tournament has completed, the operator logs into the hardware server via shell access and runs a script that awards prizes relative to the player's positioning in the tournament.

The process of awarding prizes alternatively could occur immediately after a tournament has completed, however by requiring an operator to initiate the awarding of prizes provides an extra security through additional scrutiny. Thus, under the preferred methods a script that awards prizes does not run without an operator's interaction.

As another alternative, the operator may receive an alarm to advise him that a specific tournament has completed. The alarm may be in the form of an e-mail message, a cellular phone call, or a pager message.

Regardless of whether players are participating in a particular tournament that can observer what is happening a particular tournament. Players who wish to observe a table must be logged into the system and have their lounge client active. To observe a table, they must click on the table and it will display to the player's screen the user names of the participants as well as the amount of chips they have remaining.

If the player wishes to observer the play at the table in real time, the player clicks on a small button that says “observe this table”. If the player clicks on the button, then the lounge client sends a message to lounge server requesting observance of a specified table. The lounge server spawns a table client that acts in special observer mode, such that the table server of the observed table will transmit data to the table client but will not accept any data received from the table client. Thus, the player can view the table but will be unable to participate in the game or interact with the players sitting at the table.

The loss limit currently used is based on the amount of credit that a player can buy in with. The system presently limits the amount of chips that a player can buy with his credit card to a limit of $1000, which may be increased on a separate request.

If a player uses a specific credit card, another player cannot use the same credit card as every instance of credit card usage is logged. Further, players' credit card information is permanently stored in the database.

The VIP feature in the present embodiment is an on-off flag. Players presently earn the VIP rating when they have been on the system for more than 5 hours. The operator can enter a requirement into the database at the time of the creation of the tournament script that requires the players who wish to joint the tournament have the VIP rating.

Preferably, however, the VIP is an integer that relates either to current playing time on the system, ring game victories and/or tournament victories. Therefore the system may then reward players who have played for a certain period of time or number of hands, or you could “handicap,” players who are better players in a tournament as in a ranking system. Thus, for example, for each hour of play on the system players receive an extra 100 tournament chips.

It should be understood from the foregoing that, while particular embodiments of the invention have been illustrated and described, various modifications can be made thereto without departing from the spirit and scope of the invention. Therefore, it is not intended that the invention be limited by the specification; instead, the scope of the present invention is intended to be limited only by the appended claims.

What is claimed is:

1. A tournament system comprising:
at least one server, said at least one server providing a means for operating a game,
a database operatively associated with said at least one server, said database providing a data structure for storing data related to said game,
wherein said at least one server permits a plurality of users to play said game over a network of computers.
